(19) United States
(12) Patent Application Publication
(10) Pub. No.: US 2002/0140985 A1
(43) Pub. Date: Oct. 3, 2002

(54) Color calibration for clustered printing

(76) Inventor: Kevin R. Hudson, Camas, WA (US)

Correspondence Address: HEWLETT-PACKARD COMPANY, Intellectual Property Administration, P.O. Box 272400, Fort Collins, CO, 80527-2400, US

(21) Appl. No.: 09/824,903

(22) Filed: Apr. 2, 2001

(51) Int. Cl. B41J 1/00; G06K 15/00; G06F 15/00

(52) U.S. Cl. 358/3.23; 358/1.9

(57) ABSTRACT

Methods and systems for automatic color calibration result in a cluster of printers having more uniform color output. Each printer within the cluster prints a color target. Each color target is measured, typically by sensors located in the print path. The data is sent to a central location for processing. Color look-up tables are constructed for each color and for each printer. The color look-up tables are formulated on a baseline characteristic of the printer in the cluster having the least dynamic range. That is, for each printer in the cluster, there is an input value for each color (e.g. cyan) wherein that input value results in the same output ink density as the baseline printer. Each printer in the cluster receives a color look-up table for each color, and incorporates that table in its color data flow.

### TECHNICAL FIELD

This invention relates to an apparatus and method for automatically calibrating a cluster of color printers, and in particular, to an apparatus and method for automatically generating a look-up table for each printer within a cluster, wherein use of the look-up tables results in the cluster of printers having a more uniform output.

### BACKGROUND

Clustered printing is the simultaneous use of a plurality of like printing devices to complete a print job. Clustered printing is particularly applicable where the print job includes a plurality of documents, but may be applied where a single document contains a large number of pages. Clusters may include two or more printers, and may include compound printers having two or more print engines within a single enclosure.

A problem encountered in clustered printing is that the color reproduction characteristics of the individual printers, or of print engines within a compound printer, are not entirely homogeneous. As a result, each printer may produce output that is measurably different from the others in terms of hue, density and other factors, even given identical input. This is particularly unacceptable in a clustered printing application, wherein visible differences between different portions of a print job may be readily noticed.

In attempting to provide a solution for output differences between a given printer and an ideal color target, it is known to formulate and to use a color calibration table. Such a table attempts to translate an original input sent to a printer into a corrected input that will result in the printer printing with the desired hue, ink density and other characteristics. While this is a step in the right direction, several problems remain.

First, while color calibration tables may make some difference in the output of an individual printer, such tables may be insufficient to make the output conform to an absolute reference. Second, where the calibration of individual printers is inadequate, the uniformity and consistency of a cluster of printers is inadequate for use in a cluster-printing environment. And third, because they have not taken into account the abilities of each printer within the cluster, prior art print calibration techniques have failed to create the best possible cluster-printing environment.

Accordingly, there is a need for an apparatus and method for automatic color calibration for clustered printing that provides the ability to automatically calibrate the color of a cluster of printers. The calibration process must improve the uniformity and consistency of a cluster of printers, and result in cluster printing of complex print jobs with uniform hue and ink density. The calibration process must consider and use as input the color gamut of each printer within the cluster when calibrating each member of the cluster.

### SUMMARY

Methods and systems for automatic and semi-automatic color calibration for clustered printing are described. Data, resulting from the printing of calibration targets by every printer in the cluster, are used to formulate a color look-up table for each printer. With the look-up tables installed in the color data flow, the output of each printer in the cluster is normalized with respect to a least dynamic printer, thereby producing nearly identical output by all printers.

According to one aspect of the invention, a calibration may be user-initiated, server-initiated or printer-initiated. A calibration is typically initiated due to the degradation of print consistency within the cluster of printers, the addition or removal of a printer from the cluster of printers, or the passage of sufficient time since a previous calibration.

Each printer within the cluster prints a color target. The color targets are representative of the color space for which it is intended that the calibration algorithm normalize the print output of the cluster. In most applications, the color targets should include patches or glyphs of varying ink density for each primary color and black.

Each color target is measured, and the measurements are converted into the appropriate units. In one implementation, sensors in the print path measure the color targets using CIELab color values. The data is sent to a central location for processing. The central location may be a “master printer” or a print server.

The data is processed, resulting in the production of color look-up tables for each color for each printer. The color look-up tables are formulated on a baseline characteristic of the printer in the cluster having the least dynamic range. That is, for each printer in the cluster, there is an input value for each color (e.g. cyan) wherein that input value results in the same output ink density as the baseline printer.

The central location then sends to each printer in the cluster a color look-up table for each color, for incorporation into each printer's color data flow. As a result, the output of the cluster of printers is more uniform.

### BRIEF DESCRIPTION OF THE DRAWINGS

The same numbers are used throughout the drawings to reference like features and components.

FIG. 1 is an illustration of a plurality of printers, including two clusters.

FIG. 2 is a portion of an exemplary color target associated with one primary color printed by one printer within a cluster.

FIG. 3 is a diagram representing sensors used to collect data from a color target printed by one of the printers within a cluster.

FIG. 4 is a diagram representing CEILab color space, showing the color gamut required for ideal printing of a target and the color gamut actually exhibited by two printers chosen from among those within a cluster.

FIG. 5 is a diagram representing the C (cyan) to L (lightness; a CIELab value) transfer function for three printers, illustrating how the printers having the lower curves (i.e. more dynamic transfer function) can be normalized to result in the same output as the printer with the upper curve (i.e. the less dynamic “baseline” printer).

FIG. 6 is a diagram illustrating two color look-up tables generated from the graphical representation of C vs. L seen in FIG. 6.

FIG. 7 is a diagram illustrating how the color look-up tables of FIG. 7 can be used to normalize the output of printers within a cluster to produce more uniform color output.

FIG. 8 is a flow diagram illustrating an automated method by which the color of a cluster of printers may be calibrated.

FIG. 9 is a flow diagram illustrating the calculation of the look-up tables.

FIG. 10 is a flow diagram illustrating a semi-automated method by which the color of a cluster of printers may be calibrated.

### DETAILED DESCRIPTION

A color calibration system and method of use for clustered printing results in more uniform output by each printer within a cluster. Each printer within the cluster prints a color target. Sensors within each printer measure each color target. The resulting data is sent to a central location, where color look-up tables for each color and for each printer are produced. The color look-up tables are formulated on a baseline characteristic of the printer in the cluster having the least dynamic range. The result yields color look-up tables for each printer having input values for each primary color that result in each printer producing the same output hue and ink density as the baseline printer. Each printer in the cluster receives color look-up tables for each color and black, and incorporates those tables in the color data flow.

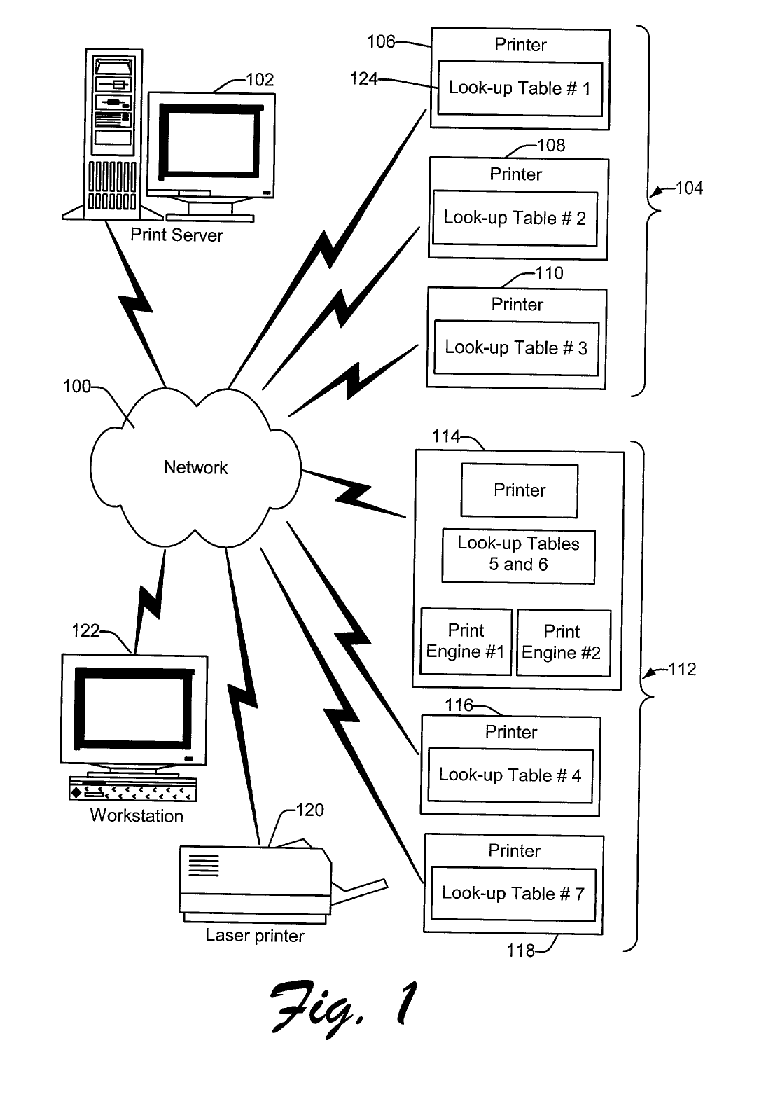

FIG. 1 illustrates first and second exemplary print clusters, all connected to a network 100, serviced by a print server 102. A first cluster 104 comprises printers 106, 108 and 110. A second cluster 112 comprises printer 114, which has multiple print engines within a single enclosure, and printers 116 and 118. An additional printer 120 is served by the print server 102, but is not associated with either cluster. A workstation 122 is connected to the network, and is able to print through either print cluster.

Each printer within a cluster is equipped with computer- or controller-readable media having computer- or controller-readable instructions, which when executed by a controller within the printer, support automatic or semi-automatic color calibration for clustered printing. Each printer is additionally equipped with a color look-up table 124. The color look-up table maps input values sent to the printer into “corrected” input values, which result in the desired output.

The printing environment of FIG. 1 is generalized, in the sense that a similar printing environment can comprise any number of servers, workstations, and printers that are coupled to one another via a data communication network 100. Network 100 can be any type of network, such as a local area network (LAN) or a wide area network (WAN), using any type of network topology and any network communication protocol. For reasons of illustrative clarity, only a few devices are shown coupled to network 100. However, in some applications the network may have tens or hundreds of devices coupled to one another. Furthermore, network 100 may be coupled to one or more other networks, thereby providing coupling between a greater number of devices. Such can be the case, for example, when networks are coupled together via the Internet.

Because the printing environment of FIG. 1 is generalized, only two printer clusters are illustrated. However, it can easily be seen that any number of printer clusters could be formed, each having any number of printers. Also because the environment of FIG. 1 is generalized, the printers shown are color ink jet printers. However, alternate implementations can be implemented in connection with color laser printers or printers based on an alternative technology.

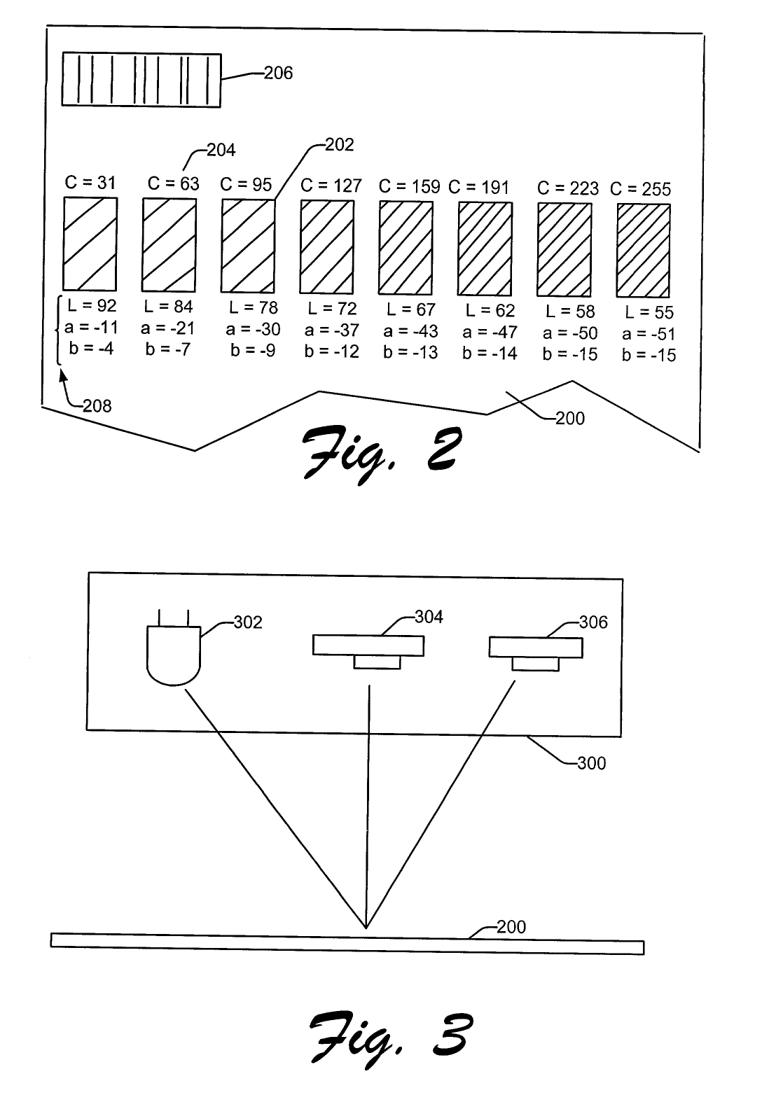

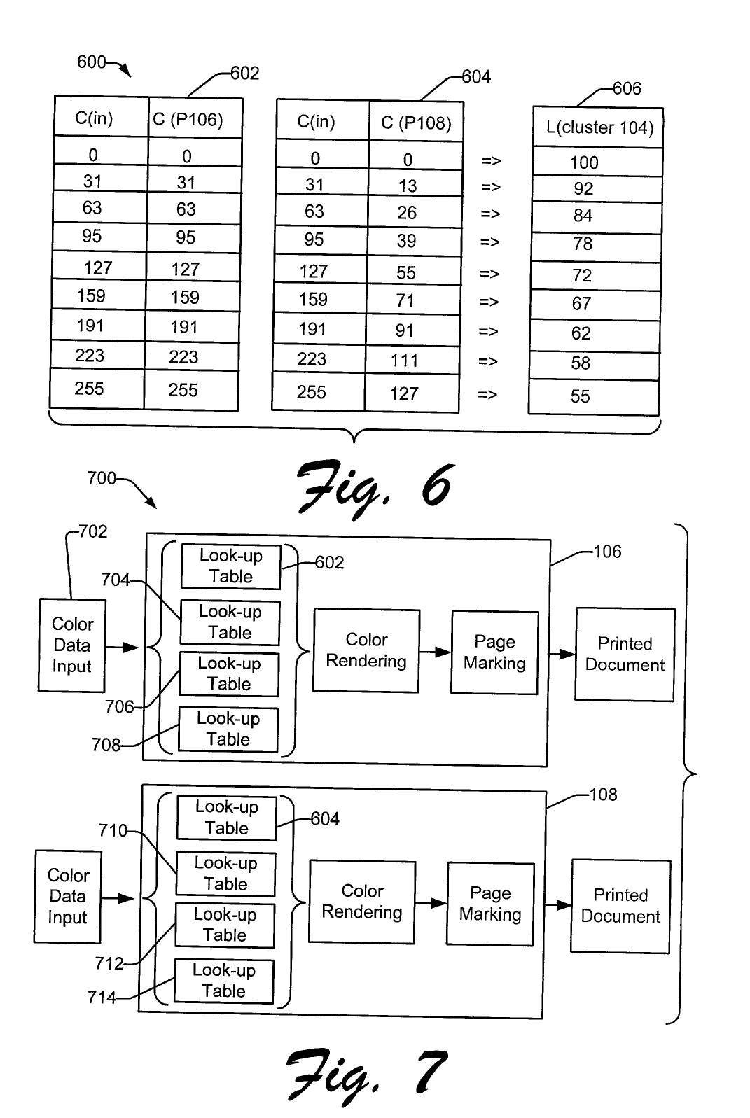

FIG. 2 shows a portion of an exemplary color target 200. The color targets are required for an evaluation process involving the sensor array 300 of FIG. 3, from which the transfer functions of FIG. 5 may be derived, and ultimately the look-up tables of FIG. 6 constructed. The color targets 200 of FIG. 2 are associated with one primary color, printed by one printer within a cluster. The portion of the target shown comprises eight color patches 202 of varying ink density for the primary color cyan (C). In an alternative implementation, a different number of color patches could be used. In a portion of the exemplary color target not illustrated to avoid repetition, eight additional patches would be printed in different intensities for each of the other primary colors, including magenta, yellow and in some applications, black. While patches of color were illustrated in FIG. 2, glyphs or other output could alternatively be associated with each primary color.

In one implementation, printers within the cluster are designed to print shades of cyan of differing intensities associated with input values 204 within a range of C=0 to C=255. To create the eight color patches, eight input values are selected from within the range 0 to 255. The input values 204 may be printed adjacent to each color patch. While the values selected are somewhat arbitrary, they are typically separated from adjacent values by an approximately equal input amount, in this case approximately 30.

In one implementation of the color target, each printer prints its name, ID or other identification 206 on the color target, typically in a format that includes a machine-readable component, such as a bar code.

As will be seen in greater detail below, after the color patches or glyphs have been scanned, numerical values 208 associated with the ink density and hue of each color patch may be printed adjacent to the patch.

FIG. 3 is a diagram representing sensor array 300 used to collect data from a color target 200 printed by one of the printers within a cluster. The sensors may be located in the paper path or each printer, so that the sensors may examine the paper immediately after printing, without the need to reload the color targets into the paper tray. As seen in FIG. 3, an LED 302 illuminates the color target 200. In the implementation of FIG. 3, a first light-to-voltage converter 304 is exposed to diffuse light moving generally perpendicularly to the color target, while a second light-to-voltage converter 306 is exposed to specular light moving away from the target at an angle equal to the angle of incidence with the target.

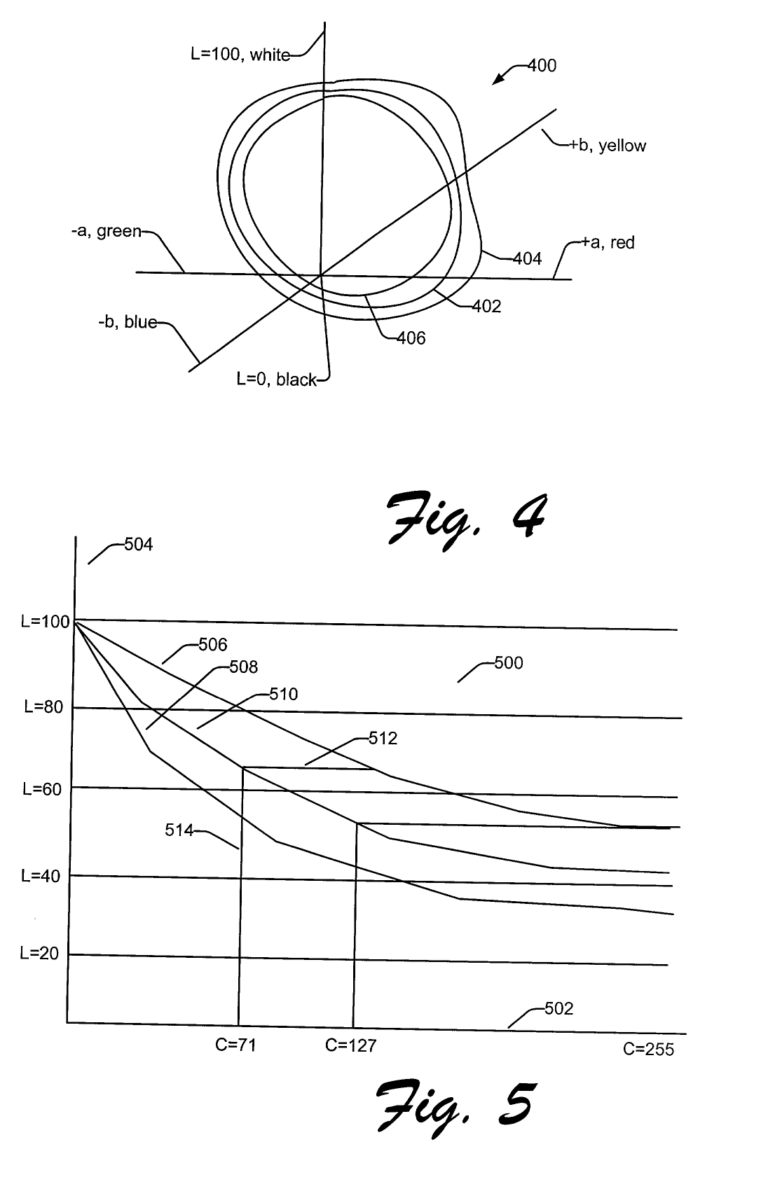

FIG. 4 is a diagram representing CIELab color space 400, which is more properly known as 1976 CIE L*a*b* Space. CIELab is the second of two standards adopted by the CIE in 1976 as color models that illustrate uniform color spacing in their values. Most Internet search engines will return information on this color model if queried regarding “CIE color space.”

In the three-dimensional view of FIG. 4, an L-axis corresponds to lightness; an a-axis is red at one end and green at the other; and a b-axis is yellow at one end and blue at the other. The diagram shows a closed curve 402 representing a three-dimensional form enclosing the color gamut required for ideal printing of a target. A second closed curve 404 represents the color gamut exhibited by a printer chosen from among those within a cluster having the ability to print the ideal target. A third closed curve 406 represents a three-dimensional form enclosing the color gamut exhibited by a printer not having the ability to print the ideal target. The third three-dimensional form 406 is entirely within, i.e. a subset of, the form 402 required for ideal printing of the target; therefore, the printer associated with form 406 would be unable to print the target in an ideal manner.

In a known manner, the light-to-voltage converters 304, 306 are able to examine the color patches 202, and obtain data from which are derived CIELab color values 208 for each patch 202. These values 208 may be printed on the paper adjacent to their respective color patches in FIG. 2 for informational purposes. However, where such printing would result in inconvenience, the association may alternatively be made in a database. Such a database record would combine a given printer's ID; the color and numerical value of the input, such as C=31; and the associated output color values, such as L=92; a=−11; and b=−4.

FIG. 5 illustrates the C (cyan) vs. L (lightness) transfer function 500 of printers 106, 108 and 110. The numerical value for C input to the printer corresponds to values along the horizontal axis 502, and the measured value of L corresponds to values along the vertical axis 504. While FIG. 5 illustrates the C (cyan) to L function, it is representative of additional figures that should be constructed in a similar manner for magenta, yellow and black. For example, an M (magenta) to L (lightness) function should also be constructed in a similar manner.

The transfer function is graphed by associating a variety of digital values input to the printer with the measured output values translated into the CIELab context. Points plotted in this manner are typically connected with a straight line to approximate the function. The upper curve 506 plotted in FIG. 5 illustrates the C (cyan) vs. L (lightness) transfer function of a printer 106 associated with the color target of FIG. 2. The lower curve 508 is associated with a second printer 108 in the same cluster. An intermediate curve 510 is associated with printer 110.

Recalling from FIG. 4 that greater values of L (lightness) correspond to larger positive numbers, it is clear from FIG. 5 that curve 506 is “lighter,” for all input values, than curves 508 and 510. Therefore, curve 506 is associated with the printer 106 having the least dynamic range within the cluster comprising printers 106, 108 and 110. A printer with a less dynamic range may be thought of as less responsive, i.e. a printer that, for any numeric input value (C), puts less ink on the white paper, therefore resulting in a lighter color target.

FIG. 5 additionally illustrates the manner in which the non-least dynamic printers 108, 110 in the cluster 104 may be normalized. Normalization is the process by which the input value (C) of one or more printers in a cluster may be mapped to a “corrected” input value which results in the same output value of L as the least dynamic printer. Normalization is an alternative to changing the transfer function of a printer, which would require modification to the hardware from which the printer is manufactured.

To normalize the curves 508 and 510 associated with printers 108 and 110 to the curve 506 associated with printer 106, horizontal lines 512 must be drawn from a plurality of locations on curves 508 and 510 to intersect curve 506. Vertical lines 514 are then drawn from the points of intersection down to the horizontal axis. Considering only printer 110 associated with transfer function 510, it can be readily seen that to produce a lightness value L=55, the input value of C to printer 110 should be 127. Similarly, to produce a lightness value of L=67, the input value of C to printer 110 should be 71.

FIG. 6 illustrates the look-up tables 124 resulting from the normalizing process illustrated by FIG. 5, which associates with each input a “corrected” input. Once normalized, the transfer functions of all of the printers within a cluster will have the same response as the least dynamic printer. Note that in the example of FIG. 6 only two printers are in the cluster; however, in an alternate application, the cluster could have additional printers. Note also that the look-up table 602, associated with printer 106 having the least dynamic range, is mapped onto itself; i.e. the values of C(in) are equal to the corrected values of C(printer 106). In contrast, the values of C(in) are consistently mapped to smaller corrected values of C(printer 108) in look-up table 604 associated with printer 108. This is because printer 108 is more dynamic than printer 106, and a smaller input value for C will result in the same output value of L. FIG. 6 illustrates only the table tables associated with one color, i.e. cyan; similar tables would be required in most implementations for magenta, yellow and black. Also, note that only nine entries (i.e. horizontal rows) are made in each table. In most applications, 256 rows would be present in each table.

The output table 606 is measured in values of L, which are associated with the cluster 104, which comprises printers 106, 108 and 110. As seen in FIG. 6, any value of C(in), sent to either printer 106, 108, is mapped to corrected values, i.e. to C(printer 106) or C(printer 108), respectively, which results in the same value of L, i.e. L(cluster 104).

FIG. 7 illustrates two printers within a color-calibrated cluster 700 of printers. Printers 106 and 108 incorporate look-up tables 602 and 604, respectively, within their color data flow. Documents 702 include values, such as C(in) which are mapped by the tables to C(printer 106) and C(printer 108), respectively. As a result, the output value, L(cluster 104), of the transfer function is consistent.

Look-up tables 704-714 represent look-up tables for magenta, yellow and black that are created in the same manner as the look-up tables for cyan. For example, look-up table 704 translates input values for magenta, whereby magenta input values sent to each printer are translated into corrected magenta input values that result in the output of the same magenta output L value.

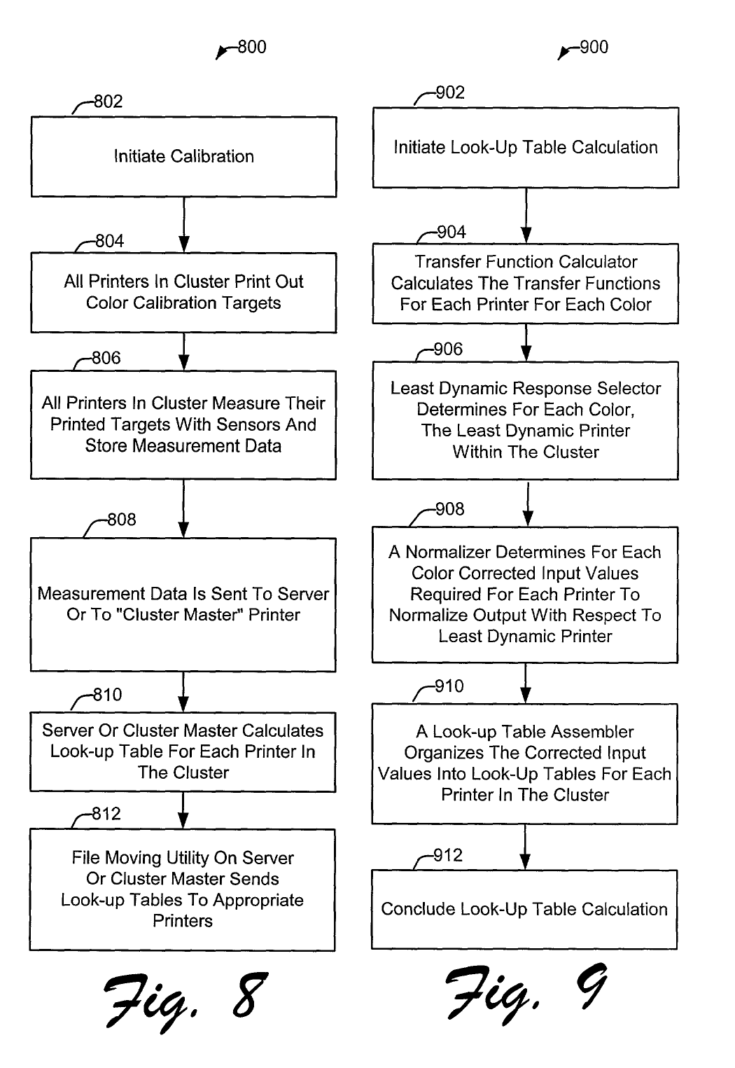

FIG. 8 shows a method for automatic operation 800 of color calibration for clustered printing. The operation 800 is particularly adapted for use in a printing environment wherein two or more printers have been identified as belonging to a cluster. The cluster must have printer-to-printer communication, which may be through a network, the Internet or functional equivalent. At least one printer or the print server must have a network address or URL of all of the printers. The printers must all have integrated color sensor hardware. At least one printer or the print server must have the means to calculate the look-up tables and other tasks. This calculation may be performed on the printer by firmware or other software that is adapted for the task, or may be performed by an application having similar functionality running on a printer server.

At block 802, calibration is initiated. A printer cluster having two or more printers, such as seen in FIG. 1, is identified.

At block 804, all printers in the cluster print out color calibration targets. A typical calibration target includes color patches, glyphs or other output. As seen in FIG. 2, where a color target is shown, a plurality of patches of each color are printed with input values distributed at generally even intervals between light and dark. As a result, a color target may include eight (or greater or fewer) patches (glyphs or other output) of differing ink density for each color (typically primary colors, such as cyan, magenta, yellow, black). The numeric input values 204, such as C=31, may also be printed for each patch or glyph. The printer's ID 206 may optionally be printed, typically in a machine-readable format.

At block 806, all printers in the cluster measure their printed targets with sensors, resulting in measurement data. As seen in FIG. 3, appropriate light-to-voltage sensors are built into the paper path of each printer. As a result, the targets may be measured immediately after printing.

At block 808, all members of the cluster send the measurement data to a “master printer” or to the print server. As seen in FIG. 1, all printers are attached to a network 100. As a result, the measurement data is easily sent to a central location.

At block 810, the print server or master printer calculates the look-up tables for each printer in the cluster. FIG. 9 illustrates an exemplary operation 900 in which the look-up tables may be calculated. At block 902, the look-up table calculation is initiated. At block 904, a transfer function calculator derives the transfer functions for each printer with respect to each color. The transfer function for one color is illustrated in FIG. 5. As a practical matter, the transfer functions maybe calculated in the manner in which they are graphically depicted, i.e. the transfer function may be approximated with a curve comprising one or more line segments. As a result, each input value (e.g. C=0, 1, 2, . . . 255) is associated with an output value of L. At block 906, a least dynamic response selector determines the least dynamic printer from within the cluster for each color. The least dynamic printer has the highest L value for any input value of C for the given color, i.e. the least dynamic printer prints more lightly, and more dynamic printers print more darkly, for any given input. At block 908, a normalizer calculates and determines the corrected input values required to normalize the more dynamic printers with respect to the least dynamic printer, i.e. to make the non-least dynamic printers print the same L value for a given value input to the least dynamic printer. This normalization process is seen in FIG. 5. At block 910, a look-up table assembler organizes the input and corrected input values into look-up tables such as those seen in FIG. 6, and at block 912 the look-up table calculation is concluded.

At block 812, a file moving utility or routine, typically located on the print server or master printer, sends each printer the look-up table associated with its color calibration target. The look-up tables are incorporated into the color data flow of each printer, as seen in FIG. 7, in a manner that allows the input sent to the printer to be substituted with corrected input, and sent to the print engine for color rendering and page marking.

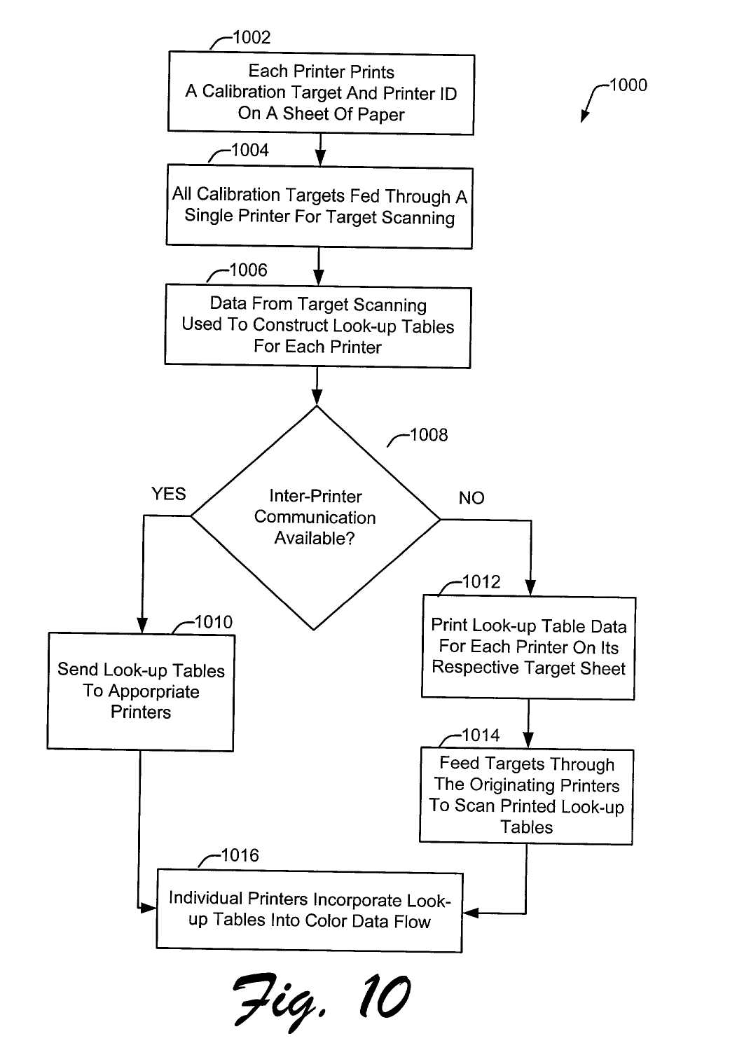

FIG. 10 illustrates a semi-automatic operation 1000 of color calibration for clustered printing. The operation 1000 is particularly adapted for use in a printing environment wherein two or more printers have been identified as belonging to a cluster. The cluster may optionally have printer-to-printer communication, which may be through a network, the Internet or functional alternative. At least one of the printers or alternate device must have color sensor hardware. At least one printer, the print server or other device must have the means to calculate the look-up tables and other tasks. This calculation may be performed on the printer by firmware or other software that is adapted for the task, or may be performed by an application having similar functionality running on a printer server.

At block 1002, in a manner similar to step 804 of method 800, each printer within the cluster prints a calibration target 200 and printer ID 206, typically in machine-readable format, on a sheet of paper. At block 1004, all of the calibration targets are fed through one or more printers or other devices for scanning. During the scanning process, sensors evaluate the hue, ink density and other factors associated with the color targets. Use of one device may be preferable where convenient, since differences between sensors will not introduce a problem due to sensor variance. Use of a number of sensing devices may be preferable where some distance separates the printers. At block 1006, in an operation similar to operation 900 seen in FIG. 9, the look-up tables are constructed for each printer in the cluster, typically by the device that scanned the color calibration targets. At block 1008, the existence of inter-printer communication is determined. If inter-printer communication is available, at block 1010 the look-up tables are sent to the appropriate printers. If not available, at block 1012 the look-up table results are printed on each printer's color calibration target or other convenient location. At block 1014, the look-up tables are scanned, keyboarded or otherwise input into each printer individually. At block 1016, each printer incorporates a look-up table in a manner similar to that seen in FIG. 7.

Although the invention has been described in language specific to structural features and/or methodological steps, it is to be understood that the invention defined in the appended claim is not necessarily limited to the specific features or steps described. Rather, the specific features and steps are disclosed as exemplary forms of implementing the claimed invention.

1. A method for calculating look-up tables for a cluster of printers, comprising:
determining a least dynamic printer in the cluster; and
calculating corrected input values required to normalize an output of at least one non-least dynamic printer in the cluster.

2. The method of claim 1, wherein transfer functions are calculated for each primary color.

3. The method of claim 1, wherein transfer functions are calculated for each primary color.

4. The method of claim 1, wherein a least dynamic printer is determined for each primary color.

5. The method of claim 1, additionally comprising calculating transfer functions for each printer in the cluster.

6. The method of claim 1, additionally comprising organizing the corrected input values into look-up tables.

7. A method for calibrating a cluster of printers, comprising:
printing a calibration target with each printer in the cluster;
measuring each calibration target to produce measurement data;
calculating transfer functions for each printer in the cluster;
determining a least dynamic printer in the cluster;
calculating corrected input values required to normalize output of non-least dynamic printers in the cluster;
organizing the corrected input values into look-up tables; and
sending the look-up tables to each printer within the cluster.

8. The method of claim 7, wherein the measuring is performed by sensors in a paper path of each printer.

9. The method of claim 7, wherein the measurement data is expressed in a CIELab context.

10. The method of claim 7, wherein the calculating steps are performed on a master printer.

11. The method of claim 7, wherein the calculating steps are performed on a print server.

12. The method of claim 7, additionally comprising incorporating the look-up tables into a color data flow of each printer in the cluster.

13. A method of calibrating a cluster of printers, comprising:
printing a calibration target with each printer in the cluster;
measuring each calibration target to produce measurement data;
calculating transfer functions for each primary color and for each printer in the cluster;
determining a least dynamic printer in the cluster with respect to each primary color;
calculating corrected input values required to normalize output of non-least dynamic printers in the cluster to the least dynamic printer in each cluster with respect to each primary color;
organizing the corrected input values into look-up tables; and
sending the look-up tables to each printer within the cluster for inclusion in a color data flow.

14. The method of claim 13, wherein the measuring is performed by sensors in a paper path of each printer.

15. A cluster of printers, comprising:
at least two printers;
a transfer function calculator to derive a transfer function for each printer with respect to at least one color;
a least dynamic response selector to determine a least dynamic printer from within the cluster of printers for at least one color;
a normalizer for calculation of corrected input values required to normalize more dynamic printers'output with respect to the least dynamic printer; and
a look-up table assembler to organize the corrected input values into look-up tables.

16. The method of claim 15, additionally comprising
a file transfer routing to send the look-up tables to each printer within the cluster of printers.

17. A computer-readable medium having computer executable instructions thereon which, when executed by a printing system, cause the printing system to:
print a calibration target with each printer in a cluster;
measure each calibration target;
calculate transfer functions for each printer in the cluster;
determine a least dynamic printer in the cluster; and
calculate corrected input values required to normalize output of non-least dynamic printers in the cluster.

18. The computer-readable medium of claim 17, additionally causing the printing system to organize the corrected input values into look-up tables.

19. The computer-readable medium of claim 18, additionally causing the printing system to send the look-up tables to each printer within the cluster for inclusion in a color data flow.

20. A system, comprising:
a transfer function calculator to derive a transfer function for each printer with respect to at least one color;
a least dynamic response selector to determine a least dynamic printer from at least two transfer functions for at least one color; and
a normalizer for calculation of corrected input values required to normalize at least one transfer function with respect to the least dynamic printer.

21. The calculator of claim 20, additionally comprising:
look-up table assembler to organize the corrected input values into look-up tables.

22. A printer containing the system of claim 20.
